(19) United States
(12) Patent Application Publication
(10) Pub. No.: US 2008/0083563 A1
(43) Pub. Date: Apr. 10, 2008

(54) Non-polarizd outdoor cord made to bridge the gap between decorating items

(76) Inventor: Marilyn Joan Elko, Glenshaw, PA (US)

Correspondence Address: MARILYN ELKO, 1540 Butler Plank Rd., GLENSHAW, PA, 15116, US

(21) Appl. No.: 11/901,500

(22) Filed: Sep. 18, 2007

Related U.S. Application Data
(60) Provisional application No. 60/849,425, filed on Oct. 5, 2006.

(51) Int. Cl. H02G 15/02

(52) U.S. Cl. 174/74 R

(57) ABSTRACT

The purpose of this invention is to eliminate unsafe, unattractive and frustrating decorating practices. No cord can connect a set of light strings to another set of light strings. All decorating lights are non-polarized. This non-polarized outdoor cord when used in conjunction with string lights (also known as end-to-end) resolves the problem of multiple items to be decorated which are not in close proximity. This cord is not polarized and therefore it can be connected to a light string set, it will transmit the electricity to the next set of lights, which is separated by space. This modified non-polarized cord overcomes the problems previously addressed in prior art.

Provisional patent file Oct. 5, 2006, Application No. 60/849,425 As well as a provisional patent filed in 2005.

### BACKGROUND OF THE INVENTION

1. Field of Invention

This invention generally relates to outdoor electric cords, and specifically to non-polarized outdoor cords. This cord is made to bridge the gap between outdoor items to be decorated without returning to a power source.

2. Prior Art

Previously, Christmas decorators needed a power cord for every outdoor item to be decorated if the items were not in close proximity. This resulted in needing to buy numerous outdoor cords to be used only for the Christmas season. Many decorators cut off grounding plugs and/or used indoor extension cords rather than buy additional outdoor cords, which are bulky, harder to store, more expensive, and less attractive. Most homes only have one outdoor receptacle with two outlets, so people have resorted to using power strips designed for indoor use. Nothing to date has resolved these issues.

While outdoor cords exist, and non-polarized cords existed in the past, no cord has been made to resolve the existing problem of decorating non-contiguous items. All extension cords are polarized and therefore useless to address this problem. No cord exists that can connect a string of lights to another string of lights. This modification (outdoor non-polarized cord) when used in conjunction with string lights resolves the problem of multiple items to be decorated which are non-contiguous. This modification will make a huge difference in decorating practices.

### OBJECTS AND ADVANTAGES

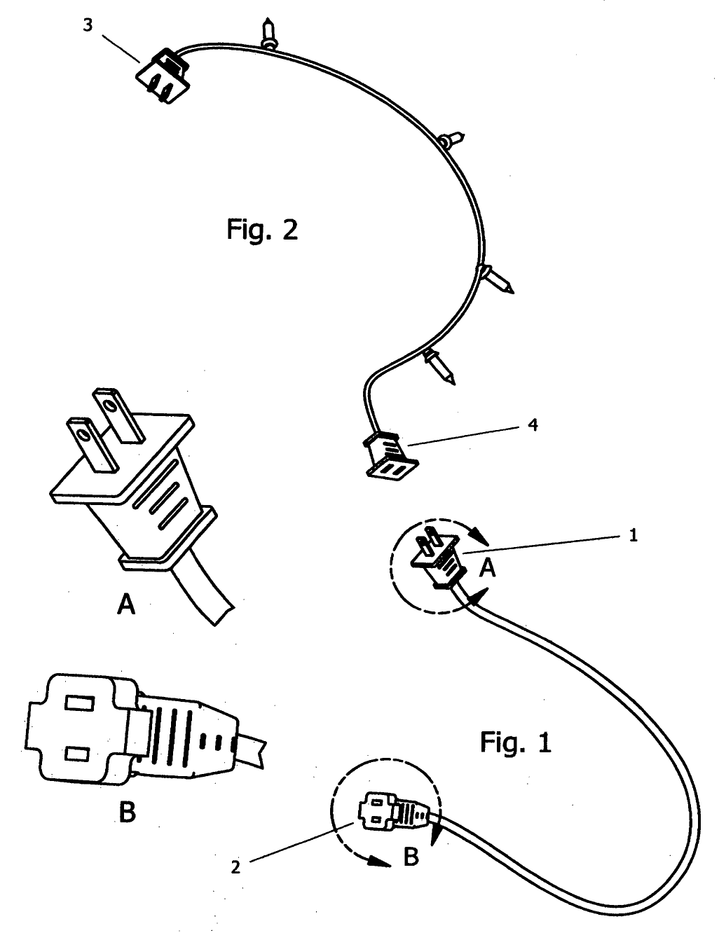

This invention is a unique electric cord with a non-polarized male end (FIG. 1) and a female end (FIG. 2) that can accommodate polarized as well as non-polarized plugs for outdoor use. All decorative light strings, (Christmas, Halloween, patio lanterns, etc.) begin with a male plug (FIG. 3) and end with a female receptacle (FIG. 4) which can only accommodate non-polarized plugs. These lights are called end-to-end or string-to-string. They can be plugged into any power source, but only another set of lights can be plugged into them. String-to-string works very well for indoor trees and along hedges and fences. However, if your shrubs or other items are not contiguous, then each will need its own power cord.

This invention resolves the problem. To use this unique cord, you plug in a regular outdoor cord to an outlet and start your light string, ending with a female receptacle. Then you plug this unique cord into the female receptacle and go wherever you want to decorate next. This cord will transmit the electricity to the next string used. This can continue throughout your yard. You can decorate several items before beginning a new power source.

This particular cord does not need a fuse because all modern string lights come with a fuse embedded. This innovation is cheaper, more attractive, safer and much easier to use. It is slightly smaller than standard outdoor cords, and therefore far easier to store. A prototype has been made, examined, and tried. It has the potential to change everyone's outdoor decorating experience.

Specifications: (A) 18 gauge copper wire; (B) jacket made for outdoor use; (C) flexible cord; (D) materials made to Underwriters Laboratory specifications; (E) non-polarized male end; (F) female end made to accommodate polarized or non-polarized plugs; (G) made in USA.

Variations: Can be made any length or any color. Can be made with embedded fuse. Can be made with 20 gauge wire.

### SUMMARY

This cord will transmit electricity from display A to display B (e.g., shrubs, porches, fences, or purchased displays). It is made to bridge the gap between decorative lights. Because all decorative lights (Christmas lights, etc.) end with a non-polarized female end, a standard polarized extension cord cannot fit into this female end. Christmas light strings are “end-to-end” strings, which means they can plug into each other.

If you were to decorate 4 outdoor bushes, each being 6 feet apart, you would need 4 separate standard extension cords going back to the main electric outlet. However, this innovative cord connects one string of lights to another without returning to the main electric outlet. This said cord resolves the problem of not enough outdoor outlets to decorate items that are separated by space.

This modified cord will make outdoor decorating easier, safer and more attractive.

1. In combination with a decorative light string having an electrical power line with a first polarized or non-polarized male plug on one end of the line and a first female receptacle on the other end of the line with a plurality of spaced lights operatively connected with the line, an electrical power cord assembly comprising a length of electric cord; a non-polarized male plug means on one end of said cord for connection with said first female receptacle and a second female receptacle means for the other end of said cord for connection to a said first male plug on another light string.
